(19) United States
(12) Patent Application Publication
(10) Pub. No.: US 2004/0193910 A1
(43) Pub. Date: Sep. 30, 2004

(54) Security filter for preventing the display of sensitive information on a video display

(75) Inventor: Bryan J. Moles, Dallas, TX (US)

Correspondence Address: Docket Clerk, P.O. Drawer 800889, Dallas, TX, 75380, US

(73) Assignee: SAMSUNG ELECTRONICS CO., LTD., Suwon-City (KR)

(21) Appl. No.: 10/401,472

(22) Filed: Mar. 28, 2003

(51) Int. Cl. G06F 11/30

(52) U.S. Cl. 713/200

(57) ABSTRACT

A display filter for preventing the display of sensitive information on the display of a processing system. The display filter comprises: 1) a data processor; 2) a memory for storing user application programs executable by the data processor and user documents associated with the user application programs; and 3) a display filter application program stored in the memory and executable by the data processor. The data processor, under control of the display filter application program, identifies sensitive information in a first selected user document and causes the first selected user document to be displayed on the display with the sensitive information obscured.

### TECHNICAL FIELD OF THE INVENTION

The present invention is generally directed to document privacy technology and, in particular, to a filter that prevents the display of sensitive information on the screen of a data processing device.

### BACKGROUND OF THE INVENTION

There are a myriad number of applications in which documents containing sensitive information may be processed by a data processing device, including a desktop personal computer (PC), a laptop PC, a handheld computer (e.g., a Palm Pilot™ or an Ipod™), a cellular phone, or a similar device. The sensitive information often includes the names of individuals, the names of businesses, product prices, marketing strategy information, schedules, technical specifications, and the like. In many cases, the sensitive information is displayed on the display (or screen) of the data processing device, or on an attached monitor screen.

The mere displaying of sensitive information poses a security problem. Even within the confines of a private office, displaying sensitive information on a screen makes it visible to other employees, many of whom may not have a need to know the sensitive information or the necessary security clearance. This problem is compounded by the portability of many data processing devices. Business travelers frequently use application programs, such as word processing programs and spreadsheet programs, in public places, such as airport terminals or on airplanes. When doing so, sensitive information is displayed on the screen of their laptop PCs and handheld PCs.

There are a few relatively limited ways to protect sensitive information when it is displayed on a screen. A mechanical screen shield on the sides of the display may be used to prevent viewing from the sides or a polarized screen filter may be used to reduce clear viewing from the sides or from a distance. The operator of a data processing device may try to be more aware of surrounding onlookers. Using very small fonts also prevents easy viewing, as does using light colored or low contrast fonts.

The disadvantages of the previous methods are generally obvious. Mechanical devices are bulky and often fragile. The use of small or light colored fonts makes it hard for the intended viewer as well as the unintended viewer. Relying on the increased diligence of the operator is notoriously useless: the weaknesses of human nature are why security technology is needed in the first place.

Therefore, there is a need in the art for improved apparatuses and methods that reduce security risks associated with the display of sensitive information on the screen of a data processing device. In particular, there is a need in the art for apparatuses and methods that reduce security risks associated with the display of sensitive information and that require a minimum of human intervention and human diligence. More particularly, there is a need in the art for apparatuses and methods that reduce security risks associated with the display of sensitive information that do not inconvenience the ability of the intended user to view the sensitive information.

### SUMMARY OF THE INVENTION

The present invention comprises a display filter that obscures sensitive information on display screens, thereby preventing unauthorized persons from viewing such information. For the purposes of this disclosure, the term “document” is not restricted to a particular type of application file, such as a word processor document or a spreadsheet document. The term “document” is used broadly herein and may refer to any type of file that contains sensitive information that may appear on a display. Thus, an HTML file associated with a webpage is considered to be a document. Similarly, an e-mail file is considered a document.

The present invention enables the user of a data processing device, such as a laptop PC or an electronic organizer, to obscure dollar amounts, e-mail addresses, street addresses, company names, personal names, passwords, product names, or any other sensitive or proprietary information.

According to one embodiment, a display filter according to the principles of the invention may be implemented as an add-on program to a particular application (e.g., MS Office, WordPerfect, a browser, an e-mail program, etc.) or to the operating system itself (e.g., MS Windows, MacOS, Linux, etc.). The present invention enables people to work on documents in public places (e.g., airplanes, airports, trains, etc.) where the privacy of the documents can be compromised. According to another embodiment, a display filter according to the principles of the present invention may be implemented directly as an integral part of an application, rather than as an add-on program to another application or as part of the operating system.

To address the above-discussed deficiencies of the prior art, it is a primary object of the present invention to provide a display filter for preventing the display of sensitive information on the display of a processing system. According to an advantageous embodiment of the present invention, the display filter comprises: 1) a data processor; 2) a memory capable of storing a plurality of user application programs executable by the is data processor and a plurality of user documents associated with the plurality of user application programs; and 3) a display filter application program stored in the memory and executable by the data processor. The data processor, under control of the display filter application program, is capable of identifying sensitive information in a first selected one of the plurality of user documents and causes the first selected user document to be displayed on the display with the sensitive information obscured. The present invention may list or enumerate the applications or documents subject to the filtering operation using a syntax that may include wildcards or regular expressions.

According to one embodiment of the present invention, the memory is further capable of storing a sensitive information database defining the sensitive information.

According to another embodiment of the present invention, the sensitive information database comprises a list of user-defined sensitive terms.

According to still another embodiment of the present invention, the sensitive information database comprises a list of user-defined sensitive graphics.

According to yet another embodiment of the present invention, the sensitive information database comprises a plurality of filter rules capable of identifying the sensitive information.

According to a further embodiment of the present invention, the data processor, under control of the display filter application, obscures the sensitive information according to a user-selected manner.

According to a still further embodiment of the present invention, the data processor, under control of the display filter application, obscures the sensitive information by covering the sensitive information with a shaded block.

According to a yet further embodiment of the present invention, the data processor, under control of the display filter application, obscures the sensitive information by replacing the sensitive information with at least one of replacement text and replacement graphics.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary processing system in accordance with one embodiment of the present invention;

FIG. 2A illustrates an exemplary document containing sensitive information displayed without any type of filtering protection on the display in FIG. 1;

FIG. 2B illustrates the exemplary document in FIG. 2A after a display filter according to the principles of the present invention has obscured sensitive information;

FIG. 3 illustrates a display filter application program according to the present invention and other related files stored in main memory; and

FIG. 4 is a flow diagram illustrating the operation of display filter application program according to one embodiment of the present invention.

### DETAILED DESCRIPTION OF THE INVENTION

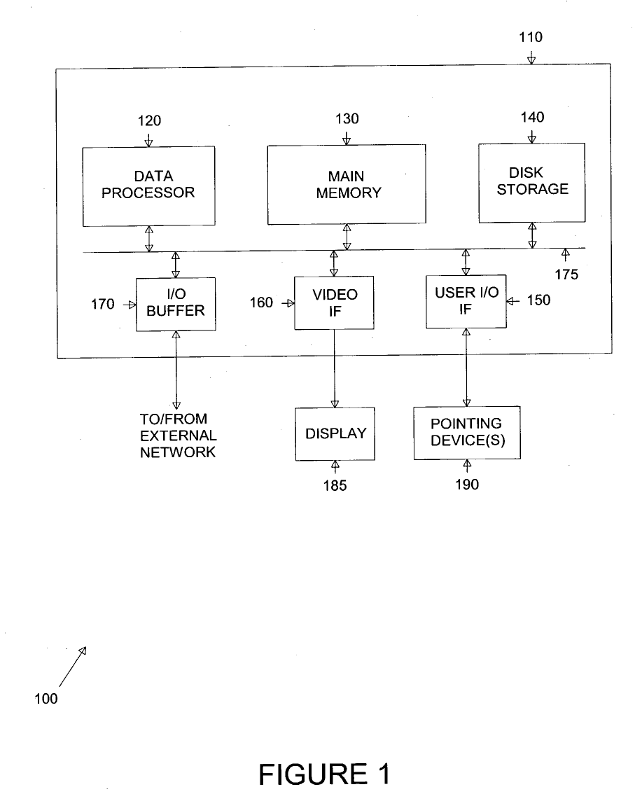

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged processing system.

FIG. 1 illustrates exemplary processing system (generally designated 100) in accordance with one embodiment of the present invention. Processing system 100 comprises personal computer (PC) 110, display 185, and pointing device(s) 190. Display 185 provides means for displaying documents as text and/or graphical images. Pointing device(s) 190 represents one or more peripheral devices that may be manipulated by an operator to generate user inputs for processing system 100. Exemplary pointing devices may include a mouse, a keyboard, a light pen, a joystick, a touch pad, or any other device that may selectively be used to enter, to select, and to manipulate data, and to move a cursor on display 185.

Processing system 110 comprises data processor 120, main memory 130 (e.g., RAM), disk storage 140, user input/output (I/O) interface (IF) 150, video interface (IF) 160, I/O buffer 170 and communication bus 175. Communication bus 175 transfers data between the various elements of processing system 110.

Data processor 120 executes application programs from memory 130. Memory 130 provides random access memory for temporary storage of data produced by data processor 120. Disk storage 140 is a non-volatile storage medium (e.g., magnetic disk) that holds application programs and data. Disk storage 140 may comprise one or more disk systems, including removable disks, for permanent storage of programs and other data.

User I/O interface 150 provides means for interfacing pointing device(s) 190 to the rest of processing system 100. User I/O interface 150 converts data received from pointing devices 190 to the format of communication bus 175 for transfer to data processor 120 or to memory 130 for subsequent access by data processor 120. Video interface 160 provides the interface between display 185 and the rest of processing system 110 via communication bus 175.

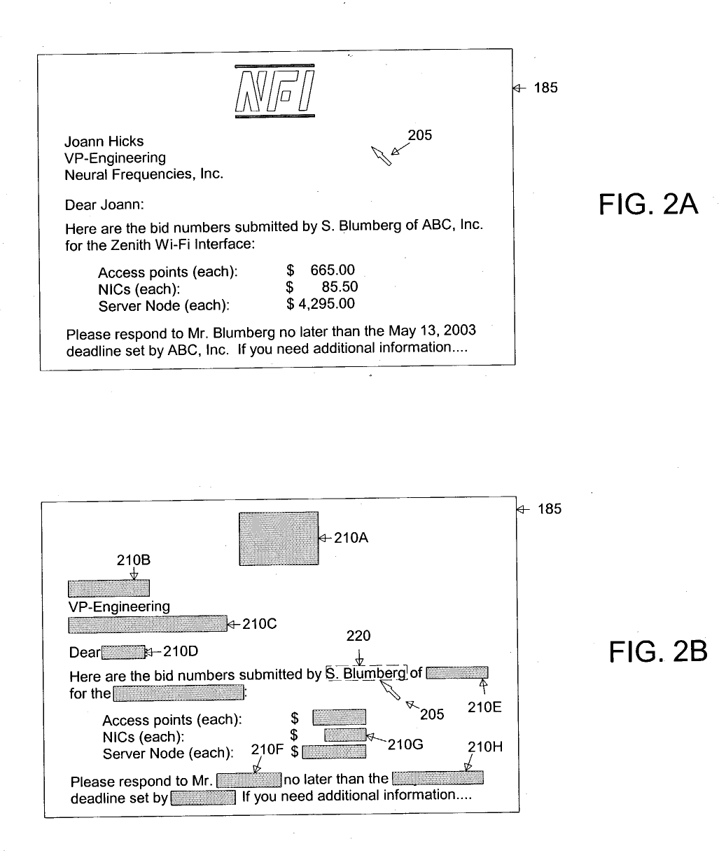

FIG. 2A illustrates an exemplary document containing sensitive information displayed without any type of filtering protection on display 185. A letter appears on display 185. The letter contains the names of persons (i.e., Joann Hicks, S. Blumberg), business names (Neural Frequencies, Inc., ABC, Inc.), product information, pricing information, the date of a deadline, and a corporate logo (i.e., NFI). Cursor 205 also appears on display 185. Because a display filter is not being used, the information appearing on display 185 may be read by anyone, including passersby.

FIG. 2B illustrates the exemplary document in FIG. 2A after a display filter according to the principles of the present invention has obscured sensitive information. The display filter has identified sensitive information on display 185 and has obscured the sensitive information. According to the principles of the present invention, the display filter identifies sensitive information by comparing words, numbers, and graphics appearing on display 185 with a list of words, numbers, and graphics stored in a sensitive information database. If a match is found, the display filter obscures the sensitive information by covering the identified words, numbers, and/or graphics with a shaded block.

Also, the display filter may identify and obscure sensitive information according to predetermined rules. For example, the display filter may automatically identify and obscure instances of dollar signs ($) followed by numerals on display 185. Similarly, the display filter may automatically identify and obscure instances of dates on display 185. Also, the display filter may automatically identify and obscure any graphics that appear on display 185.

According to an advantageous embodiment, the display filter of the present invention also monitors the position of cursor 205 on display 185. When cursor 205 is positioned on (or very near) a shaded block covering sensitive information, the display filter removes the shaded block, so that the sensitive information is again visible and may be read. In one embodiment, is the display filter removes the shaded block for as long as cursor 295 is on or near the shaded block. In an alternate embodiment, the display filter removes the shaded block only for a pre-determined period of time. For example, the display filter may remove the shaded block for a period of five (5) seconds, even if cursor 205 remains on the shaded block. This prevents sensitive information from being continually displayed if the operator is interrupted and leaves the area of processing system 100 while a sensitive document appears on display 185.

In the illustrated example, the display filter has identified the “NFI” graphic in the letterhead and has obscured the graphic with shaded block 210A. The personal name “Joann Hicks” has been obscured in the address block by shaded block 210B. The business name “Neural Frequencies, Inc.” has been obscured by shaded block 210C. The display filter has also obscured the name “Joann” in the salutation of the letter with shaded block 210D.

In the body of the letter, the display filter has covered the name “ABC, Inc.” in two instances, including with shaded block 210E. Pricing information is covered by several shaded blocks, including shaded block 210G. The display filter has obscured the date “May 13, 2003” with shaded block 210H.

The display filter also normally covers the name “S. Blumberg” in the first line of the letter with a shaded block. However, because cursor 205 is positioned on or near the shaded block, the display filter removes the shaded block so that the name “S. Blumberg” is again visible. Optionally, when the shaded block is removed, the display filter may indicate the location of the shaded block by using dotted line 220.

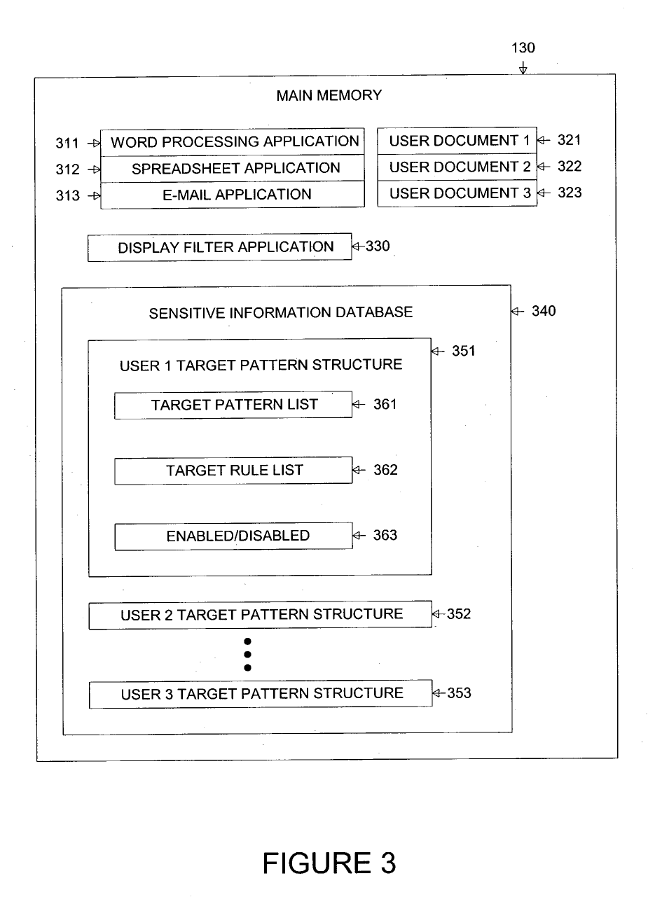

FIG. 3 illustrates exemplary display filter application program 330 and other related files stored in main memory 130. Main memory 130 contains word processing application program 311, spreadsheet application program 312 and e-mail application program 313. Other application programs may include, for example, a browser. Main memory also stores user documents 321-323. User documents 321-323 are arbitrarily labeled User Document 1, User Document 2, and User Document 3, respectively. According to an exemplary embodiment, user document 321 is a text file that is processed by word processing application program 311, user document 322 is a spreadsheet file that is processed by spreadsheet application program 312, and user document 323 is an e-mail file that is processed by e-mail application program 313.

Main memory 130 also stores sensitive information database 340. Sensitive information database 340 comprises N user target pattern structures, including user target pattern structures 351, 352 and 353. User target pattern structures 351, 352 and 353 are arbitrarily labeled User 1 Target Pattern Structure, User 2 Target Pattern Structure, and User N Target Pattern Structure. Exemplary user target pattern structure 351 comprises target pattern list 361, target rule list 362, and enabled/disabled value 363. User target pattern structures 352 and 353 are substantially similar to user target pattern structure 351 and need not be discussed separately from user target pattern structure 351.

Target pattern list 361 comprises a list of patterns defining screen objects (e.g., text strings, pictures, icons, etc.) that are to be obscured. Target rule list 362 comprises a corresponding set of rules for each pattern in target pattern list 261 that governs the manner in which the target object is to be obscured (e.g., blacked out, pale color, substitute misleading text, tiny font, etc.). Enabled/disabled value 363 indicates whether display filter application program 330 is enabled or disabled. According to an advantageous embodiment of the present invention, separate target pattern lists 361, separate target rule lists 362, and separate Enabled/Disabled values 363 may be provided for each application, and possibly even each document.

As is commonly known, there is an existing low-level function in every conventional operating system that displays text on the screen. For the purposes of illustration, this low-level function shall be referred to hereafter as “TextOut ( )”. Those skilled in the art will appreciate that similar functions exist for pictures, icons, and other screen graphics.

In normal operation, an application program displays text by calling the TextOut ( ) function with parameters that specify: 1) the text string to be displayed, 2) the position of text on the screen, 3) attributes of the text (e.g., font, size, color, boldness, etc.); and 4) possibly other parameters. According to one embodiment of the present invention, display filter application 330 replaces the conventional TextOut ( ) function with a special version of the same function that has intrinsic knowledge of the presence of target pattern list 361 and target rule list 363.

When an application program (e.g., word processing application program 311) is run and a document is loaded, the application program will, under normal operation, make many calls to the special version TextOut ( ) function in order to display the document text. The application program is unaware that a special version of the TextOut ( ) function is being called.

According to the principles of the present invention, when the special version of TextOut ( ) function is called, the status of Enabled/Disabled value 363 is initially checked. If it is enabled, then the text passed by the application program is scanned for patterns listed in target pattern list 361. If a pattern matches, the corresponding entry in target rule list 362 is examined to determine the applicable rule for obscuring. The rules are followed such that the modified text (or its replacement) is displayed instead of the actual text passed by the application program. If Enabled/Disabled value 363 is disabled, then the actual text is displayed normally.

In addition to the run-time behavior described above, display filter application program 330 provides a graphical user interface that enables a user to edit and control: 1) the content of target pattern list 361; 2) the content of target rule list 362; and 3) the status of Enabled/Disabled value 363. Each of these can be controlled through command-line options, OS environment variables, configuration files that the user can edit, GUI controls (like menus, buttons, or dialog boxes), and the like. Enabled/Disabled value 363 controls the global enablement of display filter application program 330 such that all obscured content returns to normal when Enabled/Disabled value 363 is disabled.

According to the principles of the present invention, display filter application program 330 and sensitive information database 340 may be implemented as part of a specific application (e.g., MS Word or Excel), as part of an operating system (e.g., MS Windows), or as part of a separately installed program whose purpose is to provide document security functionality to other programs. If the present invention is implemented as part of an application program, then enabling display filter application program 330 only applies rules to text patterns matched within the application program. In such a case, display filter application program 330 would not affect text in other application programs. If display filter application program 330 is implemented in the OS or as an separately installed program, display filter application program 330 may provide an additional user-editable list itemizing those application program s to which display filter application program 330 should be applied.

While a user is editing or viewing a document for which the display filter application program 330 is enabled, the user may want to see the real text in one particular obscured area. In this case, the user can hover a pointing device (e.g., mouse) over the obscured area. When this is done, only that particular text is displayed normally. The text returns to its obscured state when the mouse is moved away. As an alternative, instead of showing the actual clear text in the same physical area as the obscured text, display filter application program 330 may display the clear text in a different place on the screen (e.g., in the lower status bar). This may be desirable because an onlooker cannot easily associate the clear text shown in one part of the screen with the obscured areas of the screen.

Display filter application program 330 may identify and obscure sensitive information according to predefined rules stored in target rule list 362. For example, display filter application program 330 may automatically identify and obscure instances of dollar signs ($) followed by numerals on display 185. An example of this is shaded block 210G in FIG. 2B. Similarly, display filter application program 330 may automatically identify and obscure instances of dates on display 185 (e.g., shaded block 210H).

Also, display filter application program 330 may automatically identify and obscure any graphics that appear on display 185 (e.g., shaded block 210A). The rules for graphics might be expressed as: 1) Obscure all graphics; 2) Obscure all graphics whose filenames match the character string “John*.*” or some other pattern; 3) Obscure only *.jpg file graphics (other choices are *.bmp, *.gif, *.tiff, etc.); and 4) Obscure only graphics embedded into the document (as opposed to stored and fetched separately as is common with HTML web pages).

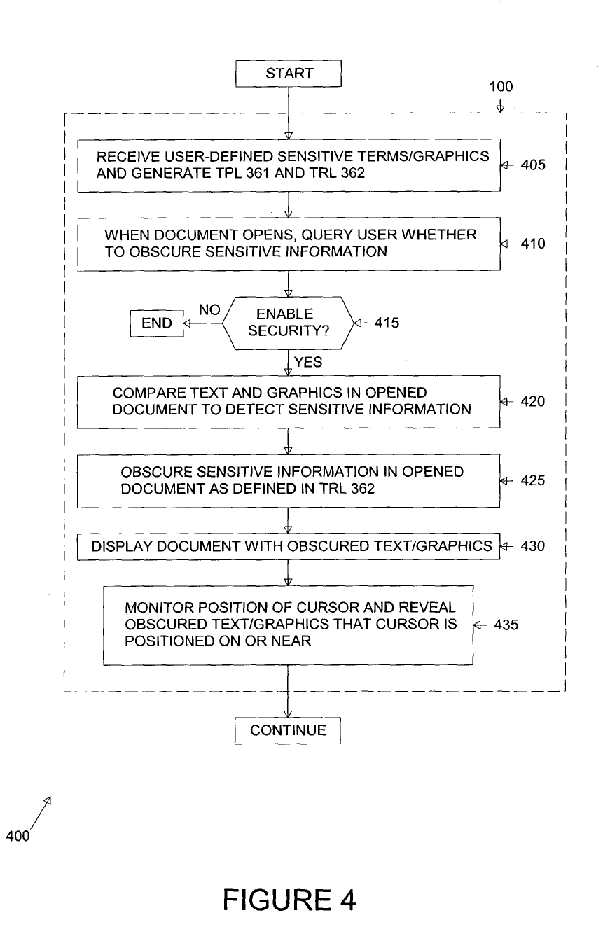

FIG. 4 depicts flow diagram 400, which illustrates the operation of display filter application program 330 according to one embodiment of the present invention. Initially, and from time-to-time thereafter, display filter application program 330 may receive user inputs from the user that define target pattern list 361 and target rule list 362, thereby indicating what text and graphics to obscure and how to obscure it. Each user of processing system 100 can therefore have a unique target pattern structure 351 (process step 405).

After target pattern structure 351 has been created, the user opens a document (e.g., user document 321) to be viewed. Next, display filter application program 330 (if activated) may query the user to determine if the user would like to open user document 321 with privacy protection enabled (process step 410). Assuming the user does want document protection, the special version TextOut ( ) function (or Graphicsout( ) function) associated with display filter application program 330 compares text and graphics in user document 311 to sensitive terms and/or graphics defined in target pattern list 361 and target rule list 362 (process steps 415 and 420). If matches occur, the special version TextOut ( ) function obscures the sensitive terms and/or graphics in the defined manner including: 1) blacking out (or shading) text and graphics; 2) replacing text and graphics with misleading substitute text and graphics (process step 425). The document with obscured terms and graphics is then displayed (process step 430).

Thereafter, display filter application program 330 monitors the position of cursor 205 on display 185. If the user moves cursor 205 to a shaded (or otherwise obscured) block in order to see the actual text and graphics, display filter application program 330 causes the special version TextOut ( ) function to temporarily remove the shaded block and the actual text and/or graphics are shown momentarily (programmable time) or until cursor 205 is moved again (process step 435). In this manner, a casual onlooker cannot easily read the document and determine its true content.

Advantageously, the present invention provides security without requiring special hardware or mechanical devices. Also, the display filter of the present invention may be customized in the privacy of a home or office. This also enables business to created individual privacy profiles to be distributed to and used by traveling employees. As noted above, display filter application program 330 may be implemented as an application-specific add-on or as separate application program.

Although the present invention has been described with an exemplary embodiment, various changes and modifications may be suggested to one skilled in the art. It is intended that the present invention encompass such changes and modifications as fall within the scope of the appended claims.

What is claimed is:

1. A display filter for preventing the display of sensitive information on the display of a processing system, said display filter comprising:
a data processor;
a memory capable of storing a plurality of user application programs executable by said data processor and a plurality of user documents associated with said plurality of user application programs; and
a display filter application program stored in said memory and executable by said data processor, wherein said data processor, under control of said display filter application program, is capable of identifying sensitive information in a first selected one of said plurality of user documents and wherein said data processor causes said first selected user document to be displayed on said display with said sensitive information obscured.

2. The display filter as set forth in claim 1 wherein said memory is further capable of storing a sensitive information database defining said sensitive information.

3. The display filter as set forth in claim 2 wherein said sensitive information database comprises a list of user-defined sensitive terms.

4. The display filter as set forth in claim 2 wherein said sensitive information database comprises a list of user-defined sensitive graphics.

5. The display filter as set forth in claim 2 wherein said sensitive information database comprises a plurality of filter rules capable of identifying said sensitive information.

6. The display filter as set forth in claim 2 wherein said data processor, under control of said display filter application, obscures said sensitive information according to a user-selected manner.

7. The display filter as set forth in claim 6 wherein said data processor, under control of said display filter application, obscures said sensitive information by covering said sensitive information with a shaded block.

8. The display filter as set forth in claim 6 wherein said data processor, under control of said display filter application, obscures said sensitive information by replacing said sensitive information with at least one of replacement text and replacement graphics.

9. For user in a processing system comprising: 1) a data processor and 2) a memory capable of storing a plurality of user application programs executable by the data processor and a plurality of user documents associated with the plurality of user application programs, a method for preventing the display of sensitive information on the display of the processing system, the method comprising the steps of:
identifying sensitive information in a first selected one of the plurality of user documents; and
displaying the first selected user document on the display with the sensitive information obscured.

10. The method as set forth in claim 9 wherein the memory is further capable of storing a sensitive information database defining the sensitive information.

11. The method as set forth in claim 10 wherein the sensitive information database comprises a list of user-defined sensitive terms.

12. The method as set forth in claim 10 wherein the sensitive information database comprises a list of user-defined sensitive graphics.

13. The method as set forth in claim 10 wherein the sensitive information database comprises a plurality of filter rules capable of identifying the sensitive information.

14. The method as set forth in claim 10 further comprising the step of obscuring the sensitive information according to a user-selected manner.

15. The method as set forth in claim 14 further comprising the step of obscuring the sensitive information by covering the sensitive information with a shaded block.

16. The method as set forth in claim 14 further comprising the step of obscuring the sensitive information by replacing the sensitive information with at least one of replacement text and replacement graphics.

17. For use in a processing system comprising: 1) a data processor and 2) a memory for storing a plurality of user application programs executable by the data processor and a plurality of user documents associated with the plurality of user application programs, a computer-readable storage medium having stored thereon a display filter application program executable by the data processor, the display filter application program comprising a plurality of instructions capable of preventing the display of sensitive information on the display of the processing system, wherein the plurality of instructions comprise the steps of:
identifying sensitive information in a first selected one of the plurality of user documents; and
causing the first selected user document to be displayed on the display with the sensitive information obscured.

18. The computer-readable storage medium as set forth in claim 17 wherein the memory is further capable of storing a sensitive information database defining the sensitive information.

19. The computer-readable storage medium as set forth in claim 18 wherein the sensitive information database comprises a list of user-defined sensitive terms.

20. The computer-readable storage medium as set forth in claim 18 wherein the sensitive information database comprises a list of user-defined sensitive graphics.

21. The computer-readable storage medium as set forth in claim 18 wherein the sensitive information database comprises a plurality of filter rules capable of identifying the sensitive information.

22. The computer-readable storage medium as set forth in claim 18 further comprising the step of obscuring the sensitive information according to a user-selected manner.

23. The computer-readable storage medium as set forth in claim 22 further comprising the step of obscuring the sensitive information by covering the sensitive information with a shaded block.

24. The computer-readable storage medium as set forth in claim 22 further comprising the step of obscuring the sensitive information by replacing the sensitive information with at least one of replacement text and replacement graphics.
